(19) United States
(12) Patent Application Publication
(10) Pub. No.: US 2026/0236635 A1
(43) Pub. Date: Aug. 13, 2026

(54) FOUR-DIMENSIONAL (4D) SIMULATION AND PRINTING

(71) Applicant: INTERNATIONAL BUSINESS MACHINES CORPORATION, Armonk, NY (US)

(72) Inventors: Jessica Nahulan, Vaughan (CA); Tiberiu Suto, Franklin, NY (US); Jeremy R. Fox, Georgetown, TX (US); Carolina Garcia Delgado, Zapopan (MX)

(21) Appl. No.: 19/047,948

(22) Filed: Feb. 7, 2025

(51) Int. Cl. G06F 30/20; G06F 3/01; G06F 11/07; G06F 30/12; G06F 113/10

(52) U.S. Cl. CPC G06F 30/20; G06F 3/016; G06F 11/0733; G06F 30/12; G06F 2113/10

(57) ABSTRACT

A method, system, and computer program product configured to perform operations including: receiving a four-dimensional (4D) print file comprising a plurality of physical attributes describing an object to be 4D printed; determining historical data describing anticipated usage parameters and environmental parameters related to the object to be 4D printed; simulating the anticipated usage parameters and the anticipated environmental parameters related to the object to be 4D printed to identify a potential issue in at least one portion of the object to be 4D printed; determining a correction to the 4D print file based on the identified potential issue; modifying the 4D print file based on the correction; and printing, using a 3D printer having 4D printing capabilities, the object to be 4D printed.

### BACKGROUND

Aspects of the present invention relate generally to methods, systems, and computer program products for modeling, simulating (e.g., performance testing), and printing four-dimensional (4D) objects.

4D printing is the process of creating objects that can change shape or function over time in response to external stimuli, such as heat, moisture, electricity, or light. It combines 3D printing techniques with materials that can adapt to environmental conditions.

### SUMMARY

In a first aspect of the invention, there is a method including: receiving a four-dimensional (4D) print file comprising a plurality of physical attributes describing an object to be 4D printed; determining historical data describing anticipated usage parameters and environmental parameters related to the object to be 4D printed; simulating the anticipated usage parameters and the anticipated environmental parameters related to the object to be 4D printed to identify a potential issue in at least one portion of the object to be 4D printed; determining a correction to the 4D print file based on the identified potential issue; modifying the 4D print file based on the correction; and printing, using a 3D printer having 4D printing capabilities, the object to be 4D printed.

In another aspect of the invention, there is a computer program product comprising one or more computer-readable storage media and program instructions stored on the one or more computer-readable storage media to perform operations comprising: receiving a four-dimensional (4D) print file comprising a plurality of physical attributes describing an object to be 4D printed; determining historical data describing anticipated usage parameters and environmental parameters related to the object to be 4D printed; simulating the anticipated usage parameters and the anticipated environmental parameters related to the object to be 4D printed to identify a potential issue in at least one portion of the object to be 4D printed; determining a correction to the 4D print file based on the identified potential issue; modifying the 4D print file based on the correction; and printing, using a 3D printer having 4D printing capabilities, the object to be 4D printed.

In another aspect of the invention, there is a computer system comprising a processor set, one or more computer-readable storage media, and program instructions stored on the one or more computer-readable storage media to cause the processor set to perform operations comprising: receiving a four-dimensional (4D) print file comprising a plurality of physical attributes describing an object to be 4D printed; determining historical data describing anticipated usage parameters and environmental parameters related to the object to be 4D printed; simulating the anticipated usage parameters and the anticipated environmental parameters related to the object to be 4D printed to identify a potential issue in at least one portion of the object to be 4D printed; determining a correction to the 4D print file based on the identified potential issue; modifying the 4D print file based on the correction; and printing, using a 3D printer having 4D printing capabilities, the object to be 4D printed.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to methods, systems, and computer program products for modeling, simulating (e.g., performance testing), and printing 4D objects. 4D printing is the process through which a 3D printed object transforms itself into another structure or shape over the influence of an external energy input such as heat, moisture, electricity, light, or other stimuli. 4D printed materials are used in fields and industries such as in the medical field for devices such as prosthetics and implants. Unfortunately, however, there are challenges in 4D printing modelling and designing, including difficulty in predicting and planning for the filament material properties changing over time. Testing a print's final outcome is difficult due to the slow actuation of the final product, along with difficulty in implementing efficient and precise control in performing the intended test conditions. Therefore, conventional systems suffer from a problem of not being able to fully test, analyze, and/or observe a printed object's intended deformation and structural changes in the presence of specific environmental factors.

Implementations of the invention address this problem by providing a method, system, and computer program product that simulates a 4D object to determine how the simulated 4D object performs over time as the simulated 4D object is exposed to external stimuli (e.g., heat, light, water, electricity, and more). In embodiments, the method, system, and computer program product provides the simulated 4D objects to a user using immersive devices (e.g., virtual reality (VR) devices, augmented reality (AR) devices, and/or haptic devices) so the user can see, touch, hear, and/or interact with the simulated 4D object in a virtual reality environment as the simulated 4D object is exposed to external stimuli over time. In embodiments, the method, system, and computer program product are configured to fast-forward, rewind, and/or freeze time as the object is virtually exposed to stimuli, to determine and/or observe the resulting behavior over time and any visual and/or structural changes that may result.

According to an aspect of the present invention, the method, system, and computer program product include: creating a 4D virtual reality digital twin model representing a design model object that can be utilized to print with a specified filament selection, model design, and print settings; predicting potential structural and cosmetic defects and flaws associated with the created 4D virtual reality digital twin by exposing the created 4D virtual reality digital twin to virtual stimuli such as environment temperature, weather, heat sources, electric source points, water and/or pressure; and generating a reaction analysis report along with an automated fix application for users to apply the recommended fixes to the created 4D virtual reality digital twin model. In embodiments, the computer-implemented method, system, and computer program product may further include printing a 4D object based on the design model object.

Implementations of the present invention are necessarily rooted in computer technology. For example, simulating the anticipated usage parameters and the anticipated environmental parameters related to the object to be 4D printed to identify a potential issue in at least one portion of the object to be 4D printed; determining a correction to the 4D print file based on the identified potential issue; modifying the 4D print file based on the correction; and printing, using a 3D printer having 4D printing capabilities, the object to be 4D printed are computer-based and cannot be performed in the human mind.

It should be understood that, to the extent implementations of the present invention collect, store, or employ personal information provided by, or obtained from, individuals (e.g., information captured during and/or for 4D modeling purposes, including implantable medical devices), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as novel 4D simulation and print code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

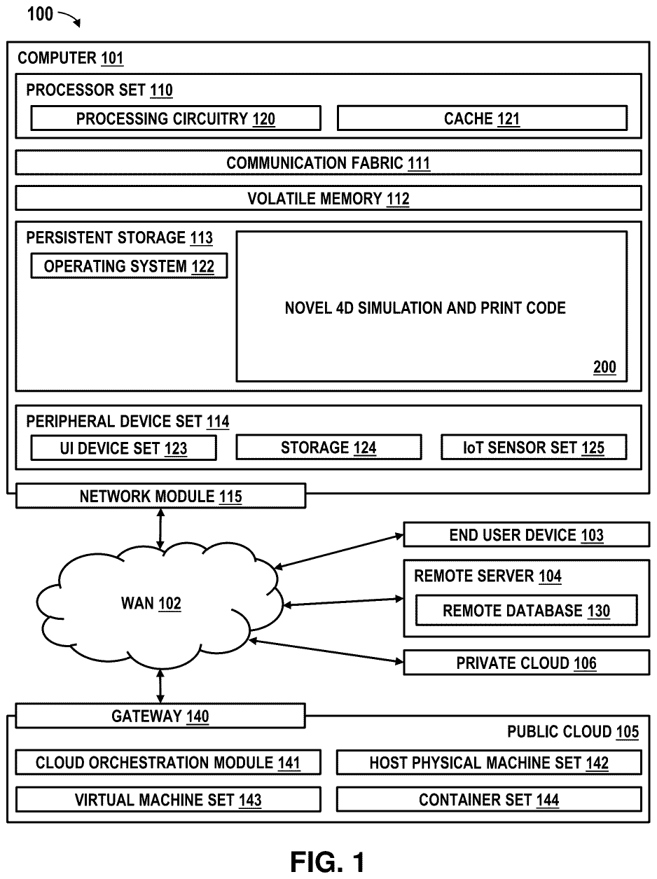

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

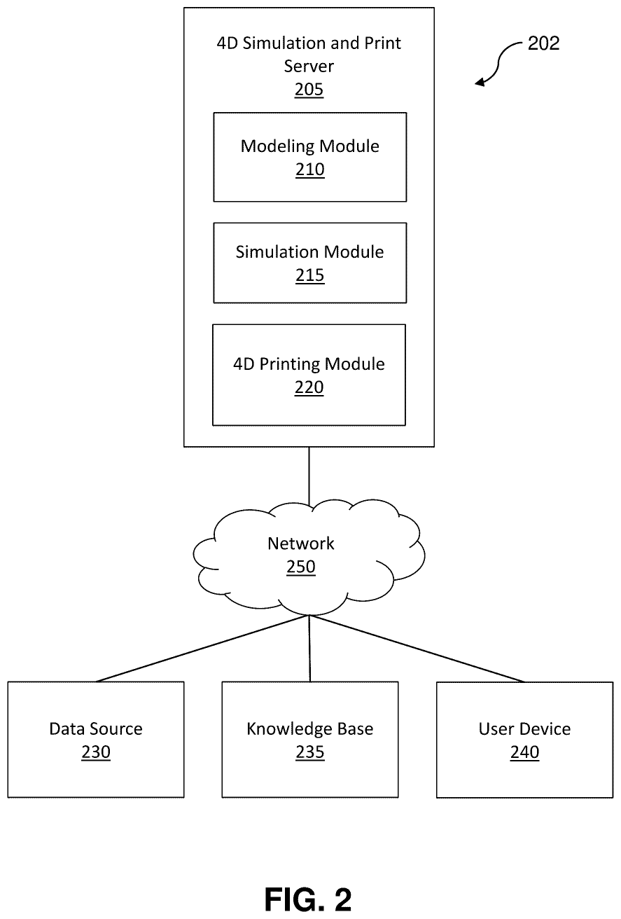

FIG. 2 shows a block diagram of exemplary environment 202 in accordance with aspects of the present invention. In embodiments, environment 202 includes 4D simulation and print server 205, data source 230, knowledge base 235, user device 240, and network 250.

4D simulation and print server 205 may comprise one or more instances of computer 101 of FIG. 1. In another example 4D simulation and print server 205 may comprise one or more virtual machines or containers running on one or more instances of computer 101 of FIG. 1. In embodiments, 4D simulation and print server 205 communicates with data source 230, knowledge base 235, and user device 240 via network 250, which may comprise WAN 102 of FIG. 1. In embodiments, data source 230 may comprise one or more data sources each comprising an instance of remote database 130 and/or remote server 104 of FIG. 1. In embodiments, knowledge base 235 may comprise one or more data sources each comprising an instance of remote database 130 and/or remote server 104 of FIG. 1. In embodiments, user device 240 comprises an instance of EUD 103 of FIG. 1. There may be plural different instances of user device 240 including, for example, personal computing devices, virtual reality devices, augmented reality devices, haptic devices, and/or any other device useful for viewing and evaluating 4D models and designs, as disclosed herein. The different instances of user device 240 may be used by different users, evaluators, operators, technicians, etc.

In embodiments, 4D simulation and print server 205 of FIG. 2 comprises modeling module 210, simulation module 215, and 4D printing module 220, each of which may comprise modules of the code of block 200 of FIG. 1. Such modules may include routines, programs, objects, components, logic, data structures, and so on that perform a particular task (or tasks) or implement a particular data type (or types) that the code of block 200 uses to carry out the functions and/or methodologies of embodiments of the present invention as described herein. These modules of the code of block 200 are executable by computer 101 of FIG. 1 (e.g., processing circuitry 120 of FIG. 1) to perform the inventive methods as described herein. 4D simulation and print server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, 4D simulation and print server 205 is configured to facilitate communication between modeling module 210, simulation module 215, 4D printing module 220, and external storage (e.g., data source 230 and/or knowledge base 235) and devices (e.g., user device 240) via network 250. For example, in embodiments, 4D simulation and print server 205 may receive, access, and/or obtain the 3D print file describing an object to be 3D printed from external storage (e.g., data source 230 and/or knowledge base 235).

In accordance with aspects of the present invention, modeling module 210 may be configured to scan a pre-manufactured object to determine physical attributes of the pre-manufactured object. As used herein, scanning refers to the process of capturing the shape, dimensions, surface texture, color information, geometry accuracy, surface smoothness, surface contours, and/or other relevant physical properties of the object. In embodiments, modeling module 210 performs that scanning using laser scanning techniques, cameras, structured light, photogrammetry, and/or any other scanning technology capable of capturing the shape and dimensions of an object. As used herein, a pre-manufactured object refers to an object that has been created, fabricated, and/or assembled prior to the scanning process. In embodiments, the pre-manufactured object may be a 3D printed object. In embodiments, scanning is performed using laser scanning, cameras, structured light, photogrammetry, and/or any other scanning technology capable of capturing the shape and dimensions of an object.

In embodiments, modeling module 210 is configured to analyze the scan data to determine scan resolution, scan noise, scan artifacts, areas of reflectivity, areas of transparency, scan scale, scan proportions, and other factors that may negatively affect the quality of the scan. In such embodiments, modeling module 210 may filter and/or modify the scan based on the analysis, by removing or correcting errors, smoothing surfaces, adjusting scale, and enhancing resolution or detail where necessary.

In embodiments, modeling module 210 is configured to generate, obtain, and/or receive a 4D print file comprising the plurality of physical attributes describing the object to be 4D printed based on the scanning results. In other words, modeling module 210 is configured to generate a 4D print file by processing the scan data to create a digital 3D model, which includes the object's shape, dimensions, surface texture, and other relevant attributes, and then converting this model into a file format suitable for 4D printing (e.g., stereolithography file (STL), object file (OBJ), and/or additive manufacturing file (AMF)). In embodiments, the 4D print file may be stored locally and/or in an external storage (e.g., data source 230 and/or knowledge base 235). In embodiments, the 4D print file may further include details such as a type of filament, type of nozzle, layer resolution, print speed, temperature settings, material properties (e.g., elasticity, thermal response), and/or any necessary supports or scaffolding for the print. These additional details ensure that the 4D print file is fully optimized for the specific printing process.

In embodiments, modeling module 210 may obtain and/or receive a 4D print file from a database (e.g., data source 230) and/or a historical corpus (e.g., knowledge base 235). In such embodiments, modeling module 210 may access the database and/or historical corpus via a network (e.g., network 250) to download and/or access the 4D print file. In other embodiments, modeling module 210 may receive the 4D print file in response to a request for the 4D print file.

In embodiments, modeling module 210 may convert the 4D print file into a 3D model, in preparation for performing 4D simulations. In such embodiments, modeling module 210 converts the 4D print file into a 3D model by extracting and interpreting the physical attributes related to shape, dimensions, structure, surface texture, material properties, and temporal behaviors, and then constructing a dynamic digital representation that includes the object's ability to adapt or transform in response to specific stimuli over time.

In accordance with aspects of the present invention, simulation module 215 is configured to determine, identify, and/or receive historical data describing anticipated usage (i.e., operational) and/or environmental parameters of the object to be 4D printed. As used herein, usage parameters for the 4D object refer to the intended or expected functions, loads, stresses, and/or other conditions the object will experience during its use as well as performance characteristics of the 4D object during its operation. In embodiments, usage parameters may include frequency of use, movement, and/or interaction with other components, materials, speed, power consumption, repetitions, rotations, operational cycles, specific performance criteria that the 4D object must meet under various conditions, and more. As used herein, environmental parameters for the 4D object refer to external conditions and/or environments the 4D object will be exposed to during its operation, such as temperature, humidity, pressure, chemical exposure, dynamic weight, dynamic pressure, dynamic heat, and other environmental factors that could affect a 4D object's performance and/or durability. In embodiments, one or more of the environmental parameters may cause the 4D object to adapt and/or transform over time. For example, an object may be printed that is not affected by heat, but when exposed to water, the same object might expand into a predetermined shape based on the material properties and temporal behaviors of the printed 4D object.

In embodiments, simulation module 215 may access and/or obtain a historical corpus for 4D object designs related to the 4D object to be printed. In such embodiments, the historical corpus may include, for example, failure timeframes, usage environment conditions, relative expense, availability impact of maintenance versus failure, and more. In embodiments, where the historical corpus for 4D object designs related to the 4D object to be printed is small (or non-existent), simulation module 215 may analyze historical results for other print patterns that have a similar design. For example, simulation module 215 may perform an operational analysis as a proxy using similar designs. In such embodiments, simulation module 215 may update the proxy analysis if and/or when historical data becomes available for the actual 4D object to be printed.

In embodiments, simulation module 215 is configured to simulate an anticipated usage, operational, and/or environmental parameters of the object to be 4D printed to identify potential issues in one or more portions of the object to be 4D printed. In embodiments, the simulation is performed using a 4D virtual reality digital twin model which represents the design model object as having been printed with the specified filament selection, model design, and/or print settings. For example, simulation module 215 may simulate how the object will perform under varying temperature conditions to identify areas where the material might weaken and/or deform, or it could simulate stress concentrations in areas of the object that may be subject to high mechanical loads. In embodiments, simulation module 215 may expose the virtual model to virtual stimuli such as environment temperature, weather, heat sources, electric source points, water and pressure. Simulation module 215 is configured to predict potential structural failures in the presence of specific environmental parameters during the simulations.

In embodiments, simulation module 215 may design simulations to test for, and identify, potential issues such as layer separation (e.g., layers can separate, leading to structural weakness), warping (e.g., heat variations and/or improper cooling can cause the object to warp and/or deform), cracking (e.g., high-stress areas or structural weaknesses can result in cracks in the printed object), delamination (e.g., in multi-material prints, different layers may separate and/or delaminate), overhang failure (e.g., unsupported and/or steep overhangs may lead to sagging and/or collapsing sections), material degradation (e.g., exposure to certain environmental conditions, such as high temperatures and/or ultra-violet (UV) light, can cause a material to degrade over time), and more.

In embodiments, simulation module 215 performs simulations for the 4D object as a whole. In other embodiments, simulation module 215 performs simulations for specific and/or each portion, zone, and/or feature of the 4D object. For example, if a 4D object has two portions, zones, and/or features, the simulation may include the entire object, the first portion, and/or the second portion.

In embodiments, simulation module 215 may be configured to fast-forward, rewind, and/or freeze time as the object is virtually exposed to stimuli, to determine and/or observe the resulting behavior over time and any visual and/or structural changes that may result. In such embodiments, simulation module 215 may use a digital twin of the object to fast-forward, rewind, and/or freeze time as the object is virtually exposed to stimuli. In embodiments, simulation module 215 may be configured to set pass and/or fail parameters for various required characteristics. Pass and/or fail parameters refer to predefined criteria and/or thresholds that determine whether the simulated behavior or performance of the 4D object meets the required specifications. These parameters may include factors such as the 4D object's ability to respond correctly to stimuli (e.g., temperature, humidity, electricity, moisture, etc.), the degree of transformation and/or adaptation achieved, and/or whether the structural integrity and functionality of the object remain intact over time under varying conditions. In embodiments, when a simulated 4D object passes and/or fails the simulation module 215 may cause a color-coded overlay on a display showing areas of the simulated 4D object that will and/or will not meet requirements under the simulated print settings (e.g., the simulated 4D object). In embodiments, simulation module 215 may further display the 4D printer settings (e.g., printer used, filament used, nozzle type, nozzle size, and more) together with the simulated 4D object so the user can view the print settings together with the simulated 4D object.

In embodiments, simulation module 215 is configured to provide and/or display the 4D object simulation using VR and/or AR devices. In embodiments, simulation module 215 may also use haptic devices (e.g., haptic gloves and/or haptic suits) to allow the user to physically interact with and/or feel the simulated 4D object. For example, a user wearing a VR device and haptic gloves, may manipulate, touch, and/or feel the 4D object as if it were a real printed object, to gain a better understanding of the conditions, behavior, and/or tactile responses, of the simulated 4D object. In other words, through these immersive devices (e.g., VR devices, AR devices, haptic devices, etc.) a user can interact with a virtual reality digital twin of the 4D object through various means, including visual (e.g., users can see the object rendered with a material to match the resulting print outcome based on filament choice), sound and/or audio (e.g., users can hear any sounds that the simulated 4D object might make when its filament materials make contact with other materials and/or are exposed to various stimuli), and touch. For example, with the above senses, users would be able to observe, touch, and hear changes that the simulated 4D object makes as simulation module 215 exposes the object to various stimuli. For instance, if an object's shape changes when exposed to water, the user would be able see and feel the resulting new shape that the virtual object takes.

In embodiments, simulation module 215 is configured to provide a simulation analysis report. In embodiments, the simulation analysis report may include user feedback, portions of the simulated 4D object that pass and/or fail, materials and/or print settings that cause a failure, and/or suggested parameters to fix and/or correct the portions of the simulated 4D object that fail. For example, the simulation analysis report may indicate that a specific portion of the 4D object fails to adapt properly to a temperature change, with an indication that the material used in that section has a low thermal response. In embodiments, the simulation analysis report may suggest using a more temperature-sensitive material and/or adjusting the print settings (such as layer thickness and/or print speed) to achieve a more acceptable performance. In embodiments, the simulation analysis report may include visual representations, such as color-coded overlays, showing areas that passed and/or failed the simulation.

In embodiments, if and/or when changes are made to the 4D print file based on the simulation analysis report and/or user feedback, simulation module 215 is configured to simulate, analyze, and test the updated printer settings until the simulated object passes. Using this iterative process simulation module 215 may determine ideal settings for a fully functional and an optimal 4D object.

Through the foregoing simulations, the simulation module 215 ensures the reliability and durability of 4D printed objects by simulating various usage, operational, and environmental conditions. By identifying potential issues such as material deformation, structural weaknesses, and failure modes before the printing process begins, it enables more informed decision-making and the optimization of the 4D printing design, including optimization of the 4D object as a whole and/or optimization of specific and/or each portion, zone, and/or feature of the 4D object. This proactive approach helps to enhance the performance, longevity, and overall quality of 4D printed objects, ultimately reducing the risk of post-production issues and improving the efficiency of the manufacturing process.

In embodiments, simulation module 215 is configured to store data related to the 4D printed object in a historical corpus (e.g., knowledge base 235). In embodiments, any data received regarding ongoing performance, failures, etc., may be collected and saved to further the corpus for subsequent print jobs and/or simulations. For example, simulation module 215 may look for changes in the rate of failure, new conditions that impact reliability, and more.

In accordance with aspects of the present invention, 4D printing module 220 is configured to print, using a local and/or external 3D printer having 4D printing capabilities, the 4D object based on the 4D print file. For example, in embodiments, 4D printing module 220 may print the object layer by layer using a specialized printer that can handle responsive materials, such as those that change shape, color, and/or properties in response to external stimuli. 4D printing module 220 may also incorporate settings from the 4D print file, such as the type of material, print speed, and layer resolution, to ensure that the printed object can exhibit the desired dynamic behaviors after printing. In embodiments, 4D printing module 220 may send signals to a local and/or external 3D printer having 4D printing capabilities to initiate and/or control a printing process based on the 4D print file. As used herein, a 3D printer having 4D printing capabilities refers to a printer that is capable of printing objects using responsive materials (e.g., filament(s)) that can undergo shape, color, and/or property changes in response to external stimuli such as temperature, light, moisture, electricity, magnetic fields, and more.

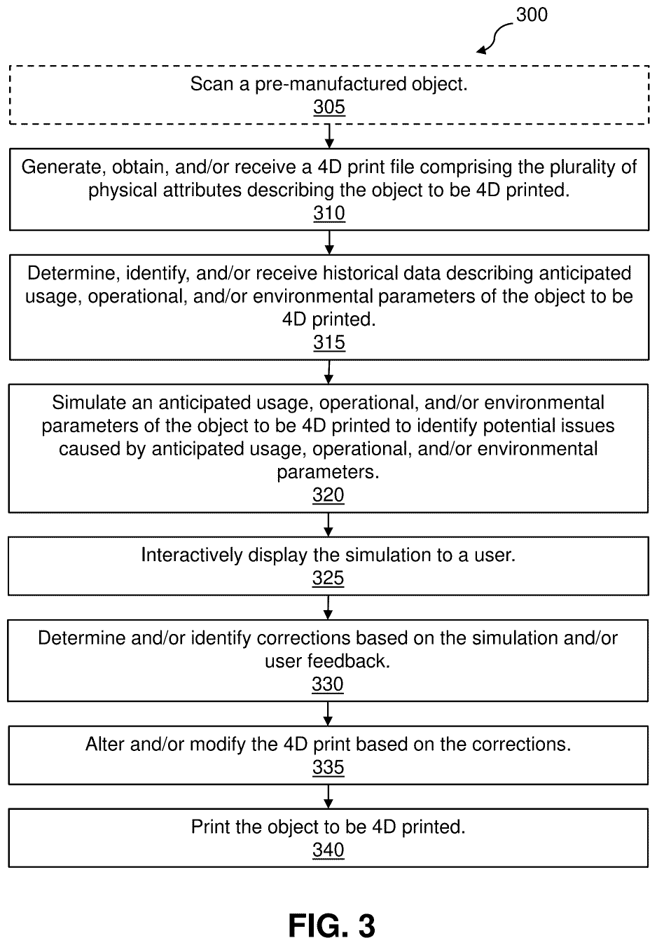

FIG. 3 shows a flow diagram of an exemplary method 300 in accordance with aspects of the present invention. Operations of the method 300 are described with reference to elements and actions depicted in and described with reference to FIG. 2.

At operation 305, the system (e.g., modeling module 210 of FIG. 2) may be optionally configured (as indicated by the dotted lines) to scan a pre-manufactured object. As provided above, scanning refers to the process of capturing the shape, dimensions, surface texture, color information, geometry accuracy, surface smoothness, surface contours, and/or other relevant physical properties of the object. Furthermore, a pre-manufactured object refers to an object that has been created, fabricated, and/or assembled prior to the scanning process. In embodiments, the pre-manufactured object may be a 4D printed object. Operation 305 may be performed in accordance with the descriptions and embodiments of modeling module 210 and with respect to FIG. 2.

At operation 310, the system (e.g., modeling module 210 of FIG. 2) is configured to generate, obtain, and/or receive a 4D print file comprising the plurality of physical attributes describing the object to be 4D printed. In embodiments, modeling module 210 is configured to generate a 4D print file by processing the scan data to create a digital 3D model, in preparation for performing 4D simulations. In embodiments the digital 3D model includes the object's shape, dimensions, surface texture, and other relevant attributes. In such embodiments, modeling module 210 converts this digital 3D model into a file format suitable for printing (e.g., stereolithography file (STL), object file (OBJ), and/or additive manufacturing file (AMF)). Operation 310 may be performed in accordance with the descriptions and embodiments of modeling module 210 and with respect to FIG. 2.

At operation 315, the system (e.g., simulation module 215 of FIG. 2) is configured to determine, identify, and/or receive historical data describing anticipated usage, operational, and/or environmental parameters of the object to be 4D printed. As noted above, in embodiments, simulation module 215 may access and/or obtain a historical corpus (e.g., knowledge base 235 of FIG. 2) for 4D object designs related to the 4D object to be printed. Operation 315 may be performed in accordance with the descriptions and embodiments of simulation module 215 with respect to FIG. 2.

At operation 320, the system (e.g., simulation module 215 of FIG. 2) is configured to simulate anticipated usage, operation, and/or environmental parameters of the object to be 4D printed, to identify potential issues caused by anticipated usage, operation, and/or environmental parameters. For example, as provided above, the simulation is performed using a 4D virtual reality digital twin model which represents the design model object as having been printed with the specified filament selection, model design, and/or print settings. In embodiments, simulation module 215 may simulate how the object will perform under varying temperature conditions to identify areas where the material might weaken and/or deform, or it could simulate stress concentrations in areas of the object that may be subject to high mechanical loads. In embodiments, simulation module 215 may expose the virtual model to virtual stimuli such as environment temperature, weather, heat sources, electric source points, water and pressure. Simulation module 215 is configured to predict potential structural failures in the presence of specific environmental parameters during the simulations. Operation 320 may be performed in accordance with the descriptions and embodiments of simulation module 215 with respect to FIG. 2.

At operation 325, the system (e.g., simulation module 215 of FIG. 2) is configured to interactively display the simulation to a user. For example, as provided above, simulation module 215 is configured to provide and/or display the 4D object simulation using VR and/or AR devices. In embodiments, simulation module 215 may also use haptic devices (e.g., haptic gloves and/or haptic suits) to allow the user to physically interact with and/or feel the simulated 4D object as if it were a real printed object. In such embodiments, the system may transmit data of the simulation to the haptic devices by a wireless communication protocol, such as Bluetooth or Wi-Fi, or through a direct wired connection to ensure real-time feedback. This allows the user to interact with and feel the simulated 4D object, providing tactile sensations that correspond to the object's dynamic behaviors, such as stretching, compressing, and/or changing shape, in response to virtual external stimuli. The haptic devices would translate these simulation data signals into physical feedback, enhancing the user's immersion and understanding of the 4D object's properties. Operation 325 may be performed in accordance with the description and embodiments of simulation module 215 and with respect to FIG. 2.

At operation 330, the system (e.g., simulation module 215 of FIG. 2) is configured to determine and/or identify corrections based on the simulation and/or user feedback. For example, simulation module 215 is configured to provide a simulation analysis report that may include user feedback, portions of the simulated 4D object that pass and/or fail, materials and/or print settings that cause a failure, and/or suggested parameters to fix and/or correct the portions of the simulated 4D object that fail. Operation 330 may be performed in accordance with the description and embodiments of simulation module 215 and with respect to FIG. 2.

At operation 335, the system (e.g., modeling module 210 of FIG. 2) is configured to alter and/or modify the 4D print file based on the determined and/or identified corrections of operation 330. In other words, as described above, modeling module 210 is configured to adjust the contents of the 4D print file to correct the issues of the simulated 4D object. Operation 335 may be performed in accordance with the description and embodiments of modeling module 210 and with respect to FIG. 2.

At operation 340, the system (e.g., 4D printing module 220) is configured to print the object to be 4D printed based on the 4D print file. Operation 340 may be performed in accordance with the description and embodiments of 4D printing module 220 and with respect to FIG. 2.

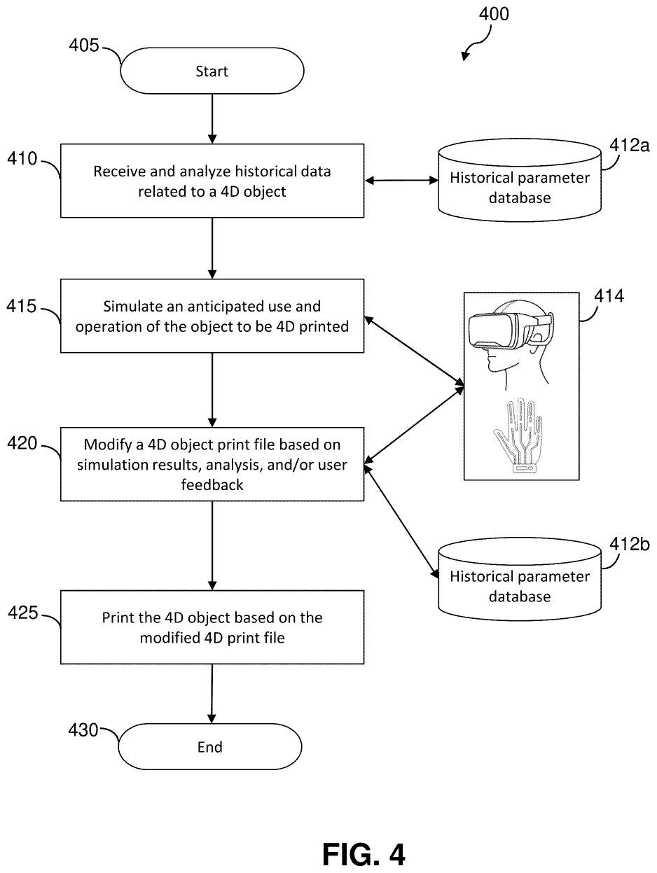

FIG. 4 shows a flow diagram of an exemplary method 400 in accordance with aspects of the present invention. Operations of the method 400 are described with reference to elements and actions depicted in and described with reference to FIGS. 2 and 3.

At operation 405, 4D simulation and print server 205 of FIG. 2 is configured to initialize method 400. At operation 410, modeling module 210 is configured to receive and analyze historical data related to a 4D object from historical parameter database 412a (e.g., one or more instances of data source 230 and/or knowledge base 235). In embodiments, operation 410 may be carried out in accordance with operation 315 of FIG. 3 and/or in accordance with the descriptions and embodiments of modeling module 210 of FIG. 2.

At operation 415, modeling module 210 is configured to simulate an anticipated use and operation of the object to be 4D printed. In embodiments, modeling module 210 is in communication with immersive devices 414, which may include VR devices, AR devices, and/or haptic devices (e.g., haptic gloves and/or haptic suits). In this manner, simulation module 215 is configured to allow the user to physically interact with and/or feel the simulated 4D object as if it were a real printed object. In embodiments, operation 415 may be carried out in accordance with operations 320-325 of FIG. 3 and/or in accordance with the descriptions and embodiments of modeling module 210 of FIG. 2.

At operation 420, modeling module 210 is configured to modify a 4D object print file based on simulation results, analysis, and/or user feedback (e.g., from immersive devices 414). For example, as noted above, simulation module 215 may be configured to provide a simulation analysis report that may include user feedback, portions of the simulated 4D object that pass and/or fail, materials and/or print settings that cause a failure, and/or suggested parameters to fix and/or correct the portions of the simulated 4D object that fail. In such embodiments, simulation module 215 may automatically, or in response to a user input, modify the 4D object print file based on the suggested parameters to fix. In embodiments, the simulation analysis report and/or the modified 4D object print file may be stored at historical parameter database 412b (e.g., one or more instances of data source 230 and/or knowledge base 235). In embodiments historical parameter database 412a and 412b are the same databases, while in other embodiments historical parameter database 412a and 412b are different databases. In embodiments, operation 420 may be carried out in accordance with operations 330-335 of FIG. 3 and/or in accordance with the descriptions and embodiments of modeling module 210 of FIG. 2.

At operation 425, 4D printing module 220 is configured to print the 4D object based on the modified 4D print file. For example, in embodiments, 4D printing module 220 may print the object layer by layer using a specialized printer that can handle responsive materials, such as those that change shape, color, and/or properties in response to external stimuli. In embodiments, operation 425 may be carried out in accordance with operation 340 of FIG. 3 and/or in accordance with the descriptions and embodiments of 4D printing module 220 of FIG. 2. At operation 430, 4D simulation and print server 205 terminates method 400.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a four-dimensional (4D) print file comprising a plurality of physical attributes describing an object to be 4D printed;
determining historical data describing anticipated usage parameters and environmental parameters related to the object to be 4D printed;
simulating the anticipated usage parameters and the anticipated environmental parameters related to the object to be 4D printed to identify a potential issue in at least one portion of the object to be 4D printed;
determining a correction to the 4D print file based on the identified potential issue;
modifying the 4D print file based on the correction; and
printing, using a 3D printer having 4D printing capabilities, the object to be 4D printed.

2. The method of claim 1, further comprising:
scanning a pre-manufactured object; and
generating the 4D print file comprising the plurality of physical attributes describing the object to be 4D printed based on the scanning.

3. The method of claim 1, further comprising generating a simulation analysis report comprising an indication of portions of the object to be 4D printed that cause a failure of the simulated 4D object.

4. The method of claim 1, wherein simulating the anticipated usage parameters and anticipated environmental parameters of the object to be 4D printed further comprises simulating anticipated operational parameters of the object to be 4D printed.

5. The method of claim 4, wherein the anticipated usage parameters comprise one or more usage parameters selected from a group consisting of: load, stress, frequency of use, movement, interaction with other components, materials, and speed.

6. The method of claim 1, wherein the anticipated environmental parameters comprise one or more environmental parameters selected from a group consisting of: temperature, humidity, pressure, electricity, and chemical exposure.

7. The method of claim 1, wherein the simulating further comprises displaying a digital twin of the object to be 4D printed using a virtual reality device.

8. The method of claim 1, wherein the simulating further comprises displaying a digital twin of the object to be 4D printed using an augmented reality device.

9. The method of claim 1, wherein the simulating further comprises transmitting data of a digital twin of the object to be 4D printed to a haptic device such that a user wearing the haptic device can interact with the digital twin of the object to be 4D printed.

10. The method of claim 1, wherein the simulating further comprises simulating a digital twin of the object to be 4D printed over time by virtually fast-forwarding time to virtually expose the digital twin of the object to be 4D printed to external stimuli and determine any structural changes to the simulated 4D object over the time.

11. A computer program product comprising:
one or more computer-readable storage media; and
program instructions stored on the one or more computer-readable storage media to perform operations comprising:
receiving a four-dimensional (4D) print file comprising a plurality of physical attributes describing an object to be 4D printed;
determining historical data describing anticipated usage parameters and environmental parameters related to the object to be 4D printed;
simulating the anticipated usage parameters and the anticipated environmental parameters related to the object to be 4D printed to identify a potential issue in at least one portion of the object to be 4D printed;
determining a correction to the 4D print file based on the identified potential issue;
modifying the 4D print file based on the correction; and
printing, using a 3D printer having 4D printing capabilities, the object to be 4D printed.

12. The computer program product of claim 11, wherein the operations further comprise:
scanning a pre-manufactured object; and
generating the 4D print file comprising the plurality of physical attributes describing the object to be 4D printed based on the scanning.

13. The computer program product of claim 11, wherein the operations further comprise generating a simulation analysis report comprising an indication of portions of the object to be 4D printed that cause a failure of the simulated 4D object.

14. The computer program product of claim 11, wherein the simulating further comprises transmitting data of a digital twin of the object to be 4D printed to a haptic device such that a user wearing the haptic device can interact with the digital twin of the object to be 4D printed.

15. The computer program product of claim 11, wherein the simulating further comprises simulating a digital twin of the object to be 4D printed over time by virtually fast-forwarding time to virtually expose the digital twin of the object to be 4D printed to external stimuli and determine any structural changes to the simulated 4D object over the time.

16. A computer system comprising:
a processor set;
one or more computer-readable storage media; and
program instructions stored on the one or more computer-readable storage media to cause the processor set to perform operations comprising:
receiving a four-dimensional (4D) print file comprising a plurality of physical attributes describing an object to be 4D printed;
determining historical data describing anticipated usage parameters and environmental parameters related to the object to be 4D printed;
simulating the anticipated usage parameters and the anticipated environmental parameters related to the object to be 4D printed to identify a potential issue in at least one portion of the object to be 4D printed;
determining a correction to the 4D print file based on the identified potential issue;
modifying the 4D print file based on the correction; and
printing, using a 3D printer having 4D printing capabilities, the object to be 4D printed.

17. The computer system of claim 16, wherein the operations further comprise:
scanning a pre-manufactured object; and
generating the 4D print file comprising the plurality of physical attributes describing the object to be 4D printed based on the scanning.

18. The computer system of claim 16, wherein the operations further comprise generating a simulation analysis report comprising an indication of portions of the object to be 4D printed that cause a failure of the simulated 4D object.

19. The computer system of claim 16, wherein simulating the anticipated usage parameters and anticipated environmental parameters of the object to be 4D printed further comprises simulating anticipated operational parameters of the object to be 4D printed.

20. The computer system of claim 16, wherein the simulating further comprises displaying a digital twin of the object to be 4D printed using a virtual reality device.
